(19) United States
(12) Patent Application Publication
(10) Pub. No.: US 2016/0322025 A1
(43) Pub. Date: Nov. 3, 2016

(54) METHOD AND APPARATUS FOR ADJUSTING DISPLAY BRIGHTNESS OF DISPLAY APPARATUS AND DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Zhihan ZHOU, Beijing (CN); Bin ZHANG, Beijing (CN); Yu XIE, Beijing (CN); Weibiao GENG, Beijing (CN)

(21) Appl. No.: 15/138,417

(22) Filed: Apr. 26, 2016

(30) Foreign Application Priority Data
Apr. 29, 2015 (CN) 201510213755.4

(51) Int. Cl. G09G 5/10; G06F 3/0488; G06F 3/0484; G06F 3/045; G06F 3/044

(52) U.S. Cl. CPC G09G 5/10; G06F 3/045; G06F 3/044; G06F 3/04847; G06F 3/04842; G06F 3/04886; G09G 2320/0626; G09G 2360/144; G09G 2354/00; G09G 2320/08

(57) ABSTRACT

Method and apparatus for adjusting display brightness of a display apparatus and the display apparatus, which can solve the problem in the known solution that the display brightness adjusting range of the display apparatus is small when adjusting the brightness of the display apparatus by adjusting the brightness of the light source. The method for adjusting display brightness of a display apparatus comprises: determining, by a brightness determining unit, display brightness needed by the display apparatus; and adjusting, by a brightness adjusting unit, brightness of the light source and/or light transmissivity of the white sub-pixel according to the display brightness determined by the brightness determining unit to obtain the display brightness needed by the display apparatus.

### TECHNICAL FIELD OF THE DISCLOSURE

The present disclosure relates to the field of display technology, in particular to a method and an apparatus for adjusting display brightness of a display apparatus, and the display apparatus.

### BACKGROUND

Usually, display brightness of a display apparatus can be adjusted to adapt the display brightness of the display to light intensity of the environment around the display apparatus to protect the user's vision.

A known method for adjusting display brightness of a display apparatus is that: when the environment around the display apparatus is dark, a light source driving chip is used to reduce the value of the input current of the light source so as to reduce the brightness of the light source and then reduce the display brightness of the display apparatus; when the environment around the display apparatus is bright, the light source driving chip is used to increase the value of the input current of the light source so as to increase the brightness of the light source and then increase the display brightness of the display apparatus.

However, inventor(s) of the present invention found during the practical research that, due to limited adjusting range of the brightness of the light source, when the display apparatus needs higher display brightness, the needed display brightness cannot be reached by adjusting the brightness of the light source, that is the display brightness adjusting range of the display apparatus is too small.

### SUMMARY

A technical problem to be solved by the present disclosure is to provide a method and an apparatus for adjusting display brightness of a display apparatus, and the display apparatus, which can solve the problem in the known solution that the display brightness adjusting range of the display apparatus is small when adjusting the brightness of the display apparatus by adjusting the brightness of the light source.

In order to achieve the above object, the present disclosure employs the following technical solutions.

A method for adjusting display brightness of a display apparatus is provided, the display apparatus comprising a light source and multiple pixel units arranged in arrays and at least one of the multiple pixel units comprising a white sub-pixel. The method comprises:

determining, by a brightness determining unit, display brightness needed by the display apparatus; and

adjusting, by a brightness adjusting unit, at least one of brightness of the light source and light transmissivity of the white sub-pixel according to the display brightness determined by the brightness determining unit to obtain the display brightness needed by the display apparatus.

The method for adjusting display brightness of a display apparatus provided by the present disclosure comprises the above steps, the display brightness of the display apparatus may be adjusted by adjusting the brightness of the light source and the light transmissivity of the white sub-pixel. Compared with the known solution that the display brightness of the display apparatus is adjusted by only adjusting the brightness of the light source, the present disclosure adds the adjustment to the light transmissivity of the white sub-pixel and thus can increase the adjusting range of the display brightness of the display apparatus. Therefore, the problem in the known solution that the brightness adjusting range is small when adjusting the brightness of the display apparatus by adjusting the light brightness can be solved.

In addition, the present disclosure also provides an apparatus for adjusting display brightness of a display apparatus, wherein the display apparatus comprises a light source and multiple pixel units arranged in arrays, at least one of the multiple pixel units comprises a white sub-pixel. The apparatus comprises:

a brightness determining unit for determining display brightness needed by the display apparatus; and

a brightness adjusting unit for adjusting at least one of brightness of the light source and light transmissivity of the white sub-pixel according to the display brightness determined by the brightness determining unit to obtain the display brightness needed by the display apparatus.

The apparatus for adjusting display brightness of a display apparatus provided by the present disclosure has the same effect as the above method for adjusting display brightness of a display apparatus relative to the known solution, which will not be repeated here.

In addition, the present disclosure also provides a display apparatus comprising a light source and multiple pixel units arranged in arrays, at least one of the pixel units comprises a white sub-pixel, and the display apparatus further comprises the apparatus for adjusting display brightness of the display apparatus as described in the above.

The display apparatus provided by the present disclosure has the same effect as the above apparatus for adjusting display brightness of the display apparatus relative to the known solution, which will not be repeated here.

### BRIEF DESCRIPTION OF THE DRAWINGS

In order to describe the technical solutions in the prior art or in embodiments of the present disclosure clearer, the figures necessary for the description of the embodiments will be briefly introduced in the following. Obviously, the figures in the following description are only some embodiments of the present disclosure. Those skilled in the art can obtain other figures based on these figures without creative work.

FIG. 1 is a flowchart of a method for adjusting display brightness of a display apparatus in an embodiment of the present disclosure;

FIG. 2 is a first structural schematic diagram of an apparatus for adjusting display brightness of a display apparatus in an embodiment of the present disclosure;

FIG. 3 is a second structural schematic diagram of an apparatus for adjusting display brightness of a display apparatus in an embodiment of the present disclosure; and

FIG. 4 is a third structural schematic diagram of an apparatus for adjusting display brightness of a display apparatus in an embodiment of the present disclosure.

### DETAILED DESCRIPTION

In the following, technical solution in embodiments of the present disclosure will be described clearly and completely in conjunction with attached drawings in embodiments of the present disclosure. Apparently, the described embodiments are only a part of embodiments of the present disclosure, but not all the embodiments. Based on embodiments of the present disclosure, all other embodiments obtained by those ordinary skills in the art without any creative work belong to the protection scope of the present disclosure.

### First Embodiment

An embodiment of the present disclosure provides a method for adjusting display brightness of a display apparatus, wherein the display apparatus comprises a light source and multiple pixel units arranged in arrays, and at least one of the multiple pixel units comprises a white sub-pixel. Exemplarily, the above light source can be a light emitting diode, an electroluminescent chip, a cold cathode fluorescent lamp or the like. The above at least one of the pixel units comprising a white sub-pixel may comprise the following situations: among the multiple pixel units arranged in arrays, part of the pixel units comprise white sub-pixels, and the pixel units comprising white sub-pixels are uniformly distributed in the part of the pixel units arranged in arrays; or the multiple pixel units arranged in arrays all comprise white sub-pixels. In order to improve the display brightness of the display apparatus, optionally, the multiple pixel units arranged in arrays all comprise white sub-pixels. Since the number of white sub-pixels is relatively large and the light transmission of the white sub-pixels is better, it is possible to improve the display brightness of the display apparatus.

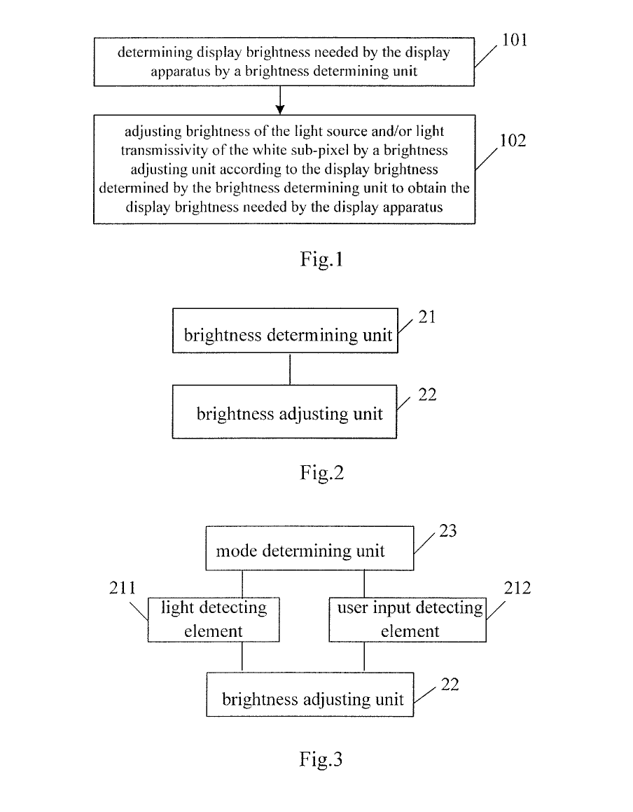

As shown in FIG. 1, the method for adjusting display brightness of a display apparatus provided by an embodiment of the present disclosure comprises the following steps.

At step 101, a brightness determining unit determines display brightness needed by the display apparatus. Exemplarily, the brightness determining unit can be an optical sensor which can detect the light intensity of the environment around the display apparatus. and then the display brightness needed by the display apparatus may be display brightness adapted to the light intensity of the environment around the display apparatus. The brightness determining unit can also be a touch unit in the display apparatus which is used to determine the display brightness needed by the display apparatus according to an instruction input by a user, and the instruction is the display brightness of the display apparatus selected by the user according to the light intensity of the environment around the display apparatus. In such a design, the display brightness of the display apparatus may be adapted to the light intensity of the environment around the display apparatus, such that the display apparatus always can display the display brightness that is adapted to the user's vision under different light intensities, which may protect the user's vision. In addition, the above touch unit can also be used to determine the display brightness needed by the display apparatus according to an instruction input by the user, and the instruction is the display brightness selected by the user according to his/her own preference. In this case, the display brightness needed by the display apparatus can be a user's preferable display brightness. In such a design, it is possible to meet the requirements of different users on the display brightness, for different users have different preference on display brightness.

At step 102, a brightness adjusting unit adjusts brightness of the light source and/or light transmissivity of the white sub-pixel according to the display brightness determined by the brightness determining unit, to obtain the display brightness needed by the display apparatus. Exemplarily, when the display brightness needed by the display apparatus is higher than the current display brightness of the display brightness, the brightness adjusting unit adjusts brightness of the light source and/or light transmissivity of the white sub-pixel according to the display brightness of the display apparatus determined by the brightness determining unit, that is, the brightness adjusting unit increases brightness of the light source and/or light transmissivity of the white sub-pixel, to improve the display brightness of the display apparatus. When the display brightness needed by the display apparatus is lower than the current display brightness of the display brightness, the brightness adjusting unit adjusts brightness of the light source and/or light transmissivity of the white sub-pixel according to the display brightness of the display apparatus determined by the brightness determining unit, that is, the brightness adjusting unit reduces brightness of the light source and/or light transmissivity of the white sub-pixel, to reduce the display brightness of the display apparatus. Since the power consumption for increasing the light transmissivity of the white sub-pixel is lower than that for increasing the brightness of the light source, in order to reduce the power consumption for improving the display brightness of the display apparatus, optionally, the brightness adjusting unit improves the display brightness of the display apparatus by increasing the light transmissivity of the white sub-pixel.

In the above embodiment, the display brightness of the display apparatus may be adjusted by adjusting the brightness of the light source and the light transmissivity of the white sub-pixel. Compared with the known solution that the display brightness of the display apparatus is adjusted by only adjusting the brightness of the light source, the present disclosure adds the adjustment to the light transmissivity of the white sub-pixel and thus can increase the adjusting range of the display brightness of the display apparatus. Therefore, the problem in the known solution that the brightness adjusting range is small when adjusting the brightness of the display apparatus by adjusting the light brightness can be solved. In addition, since the power consumption for increasing the light transmissivity of the white sub-pixel is lower than that for increasing the brightness of the light source, the method provided in the present disclosure has lower power consumption.

Further, before step 101, the method for adjusting display brightness of a display apparatus can further comprise: determining, by a mode determining unit, a brightness determining mode, wherein the brightness determining mode includes an automatic mode and a manual mode. Exemplarily, a determining method of the brightness determining mode can be: detecting the brightness determining mode input by the user through the mode determining unit to determine it as the automatic mode or the manual mode; or setting the brightness determining mode as the automatic mode through the mode determining unit when the display apparatus is turned on. Now, in step 101, the step of determining the needed display brightness by the brightness determining unit in particular comprises: detecting, by a light detecting element, light intensity of the environment around the display apparatus to determine the display brightness needed by the display apparatus when the automatic mode is determined; detecting, by a user input detecting element, display brightness input by a user according to the light intensity of the environment around the display apparatus when the manual mode is determined. Since the brightness determining mode includes the automatic mode and the manual mode, when the user's requirement is relatively high, he/she may manually input the display brightness of the display apparatus, and when the user's requirement is relatively low, the display brightness of the display apparatus may be automatically determined by the light detecting element, such that it is possible to meet the requirements of different users on the display brightness.

In the above embodiment, exemplarily, the light detecting element can be a light sensor, and when the automatic mode is determined, the light sensor detects the light intensity of the environment around the display apparatus to determine the display brightness needed by the display apparatus. The user input detecting element can be a resistance touch element or a capacitance touch element, and when the manual mode is determined, the touch element detects the display brightness input by the user to determine the display brightness needed by the display apparatus. Exemplarily, the method for detecting the display brightness input by the user can be as follows. There is a brightness adjusting bar in the display screen of the display apparatus, different positions of a point in the brightness adjusting bar represent different display brightness, and the user can select needed display brightness by adjusting the position of the point in the brightness adjusting bar, such that it is possible to detect the display brightness input by the user by detecting the display brightness selected by the user through the brightness adjusting bar; or there is a brightness input box in the display screen of the display apparatus, and then it is possible to detect the display brightness input by the user by detecting the value input directly by the user. In such a design, it not only enables the users who are not familiar with display brightness values to select the display brightness through the brightness adjusting bar, but also enables the users who are familiar with display brightness values to select the display brightness through directly input a value of the display brightness, such that it is possible to meet different users' requirements.

In the above embodiment, exemplarily, in step 102, the step of adjusting the brightness of the light source and/or the light transmissivity of the white sub-pixel by the brightness adjusting unit in particular comprises: changing duty ratio or current intensity of the input current of the light source by a light source brightness adjusting element so as to adjust the brightness of the light source; and/or adjusting the light transmissivity of the white sub-pixel by a gray scale adjusting element. Exemplarily, the light source brightness adjusting element can be a light source driving chip, and the gray scale adjusting element can be a gray scale control chip. When the display brightness needed by the display apparatus is higher than the current display brightness of the display apparatus, it is possible to change the duty ratio or the current intensity of the current input into the light source by the light source driving chip, that is, increase the duty ratio or the current value of the current input into the light source by the light source driving chip; and/or change the light transmissivity of the white sub-pixel by the gray scale control chip, that is, increase the light transmissivity of the white sub-pixel by the gray scale control chip, to increase the gray scale of the white sub-pixel, such as to improve the display brightness of the display apparatus. When the display brightness needed by the display apparatus is lower than the current display brightness of the display apparatus, the process is opposite to the above process.

Further, after step 101 and before step 102, the method for adjusting display brightness of the display apparatus may further comprises: transmitting a brightness control signal to the brightness adjusting unit by the brightness determining unit to make the brightness adjusting unit receive the brightness control signal. Display brightness of different display apparatus are corresponding to different brightness control signals. Now, the method of step 102 may in particular be: adjusting the brightness of the light source and/or the light transmissivity of the white sub-pixel by the brightness adjusting unit according to the brightness control signal received by the brightness adjusting unit. Exemplarily, the brightness determining unit transmits a corresponding brightness control signal to the brightness adjusting unit according to different display brightness after determining the display brightness needed by the display apparatus, and then the brightness adjusting unit adjusts the brightness of the light source and the light transmissivity of the white sub-pixel according to the above brightness control signal. Since the brightness determining unit automatically transmits the brightness control signal to the brightness adjusting unit after determining the display brightness needed by the display apparatus and the brightness adjusting unit automatically adjusts the brightness of the light source and the light transmissivity of the white sub-pixel according to different brightness control signals, the above adjusting process can be automatically completed after the display brightness needed by the display apparatus is determined so as to obtain the display brightness needed by the display apparatus. In addition, when the brightness determining unit is the light detecting element, it is possible to automatically detect the light intensity of the environment around the display apparatus and automatically adjust the display brightness of the display apparatus according to the light intensity of the environment around it, without involving the user, such that the process of adjusting the display brightness of the display apparatus is more convenient.

### Second Embodiment

An embodiment of the present disclosure provides an adjusting apparatus for adjusting display brightness of a display apparatus. The display apparatus comprises a light source and multiple pixel units arranged in arrays and at least one of the pixel units comprises a white sub-pixel. As shown in FIG. 2, the adjusting apparatus comprises: a brightness determining unit 21 for determining display brightness needed by the display apparatus; and a brightness adjusting unit 22 for adjusting at least one of brightness of the light source and light transmissivity of the white sub-pixel according to the display brightness determined by the brightness determining unit to obtain the display brightness needed by the display apparatus.

In the above embodiment, since the adjusting apparatus can adjust the brightness of the light source and the light transmissivity of the white sub-pixel to adjust the display brightness of the display apparatus, compared with the known solution that the adjusting apparatus only adjusts the display brightness of the display apparatus by adjusting the brightness of the light source, the present disclosure adds the adjustment to the light transmissivity of the white sub-pixel and thus can increase the adjusting range of the display brightness of the display apparatus. Therefore, it is possible to solve the problem in the known solution that the brightness adjusting range is small when adjusting the brightness of the display apparatus by adjusting the light brightness. In addition, since the power consumption for the adjusting apparatus to increase the light transmissivity of the white sub-pixel is lower than the power consumption for the adjusting apparatus to increase the brightness of the light source, compared with the known solutions, the display apparatus has lower power consumption when the adjusting apparatus provided in the present disclosure improves the display brightness.

Further, as shown in FIG. 3, the adjusting apparatus can further comprise a mode determining unit 23 for determining a brightness determining mode, and the brightness determining mode includes an automatic mode and a manual mode. Now, the brightness determining unit 21 comprises a light detecting element 211 and a user input detecting element 212. The light detecting element 211 is used for detecting light intensity of the environment around the display apparatus to determine the display brightness needed by the display apparatus when the automatic mode is determined; and the user input detecting element 212 is used for detecting display brightness input by a user to determine the display brightness needed by the display apparatus when the manual mode is determined. It is to be noted that the mode determining unit 23 connects to the light detecting element 211 and the user input detecting element 212 respectively.

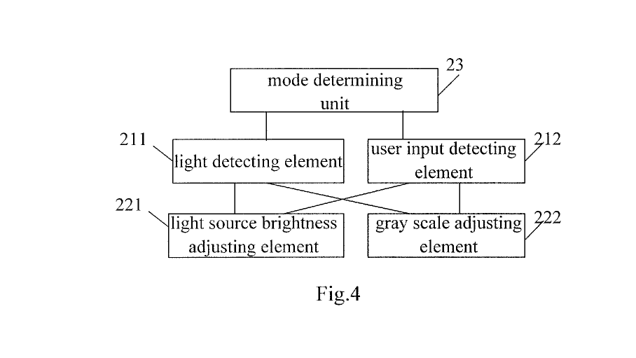

In the above embodiment, exemplarily, as shown in FIG. 4, the brightness adjusting unit 22 comprises a light source brightness adjusting element 221 and a gray scale adjusting element 222. The light source brightness adjusting element 221 is used for changing duty ratio or current intensity of the input current of the light source to adjust the brightness of the light source; and the gray scale adjusting element 222 is used for adjusting the light transmissivity of the white sub-pixel.

In the above embodiment, exemplarily, the brightness determining unit 21 is also used for transmitting a brightness control signal to the brightness adjusting unit 22 according to the determined brightness; and the brightness adjusting unit 22 receives the brightness control signal to adjust the brightness of the light source and/or the light transmissivity of the white sub-pixel. As shown in FIG. 4, when the brightness adjusting unit 22 comprises the light source brightness adjusting element 221 and the gray scale adjusting element 222, the light detecting element 211 is connected to the light source brightness adjusting element 221 and the gray scale adjusting element 222 respectively through electrical signals, and the user input detecting element is connected to the light source brightness adjusting element 221 and the gray scale adjusting element 222 respectively through electrical signals

In addition, an embodiment of the present disclosure further provides a display apparatus which can be any product or component with display function, such as electronic paper, a cell phone, a tablet computer, a television, a display, a notebook computer, a navigator or the like. The display apparatus comprises a light source and multiple pixel units arranged in arrays, and at least one of the pixel units comprises a white sub-pixel. The display apparatus further comprises an adjusting apparatus for adjusting display brightness of the display apparatus as described in the above embodiment. The light source is located in the backlight module of the display apparatus, the pixel units are located in the display panel of the display apparatus, and the adjusting apparatus is connected to the backlight module and the display panel through electric signals.

The same or similar parts of respective embodiments in the present specification can refer to each other, and each embodiment emphasizes its difference from other embodiments. In particular, for the apparatus embodiment, its description is simple since it is basically similar to the method embodiment, and the related parts may refer to the description of the method embodiment.

It is to be noted that the above-described apparatus embodiments are only for illustration. The unit described as separate part may be or may not be physically separated. The part shown as unit may be or may not be physical unit, that is, can be located at one position or can be distributed over multiple network units. It is possible to select part or all of the modules as needed in practice to achieve the object of the embodiment solutions. In addition, in the drawings of the apparatus embodiments provided by the present disclosure, the connection relationship between those modules represent that there is a connection between them, in particular, the connection can be embodied by one or more signal lines. Those skilled in the art can understand and implement that without creative work.

The above descriptions are only specific embodiments of the present disclosure, but are not used to limit the protection scope of the present disclosure. Any modification or replacement that can be easily thought of by those skilled in the art within the technical scope of the present disclosure should fall within the protection scope of the present disclosure. Therefore, the protection scope of the present disclosure should be defined by the protection scope of the claims.

The present disclosure claims the priority of the patent application No. 201510213755.4 with a tile of “METHOD AND APPARATUS FOR ADJUSTING DISPLAY BRIGHTNESS OF DISPLAY APPARATUS AND DISPLAY APPARATUS” filed by the present applicant on Apr. 29, 2015 in the mainland of China.

What is claimed is:

1. A method for adjusting display brightness of a display apparatus, the display apparatus comprising a light source and multiple pixel units arranged in arrays and at least one of the multiple pixel units comprising a white sub-pixel, the method comprising:
determining, by a brightness determining unit, display brightness needed by the display apparatus; and
adjusting, by a brightness adjusting unit, at least one of brightness of the light source and light transmissivity of the white sub-pixel according to the display brightness determined by the brightness determining unit to obtain the display brightness needed by the display apparatus.

2. The method according to claim 1, before determining, by a brightness determining unit, display brightness needed by the display apparatus, further comprising:
determining, by a mode determining unit, a brightness determining mode, the brightness determining mode including an automatic mode and a manual mode;
detecting, by a light detecting element, light intensity of the environment around the display apparatus to determine the display brightness needed by the display apparatus when the automatic mode is determined; and
detecting, by a user input detecting element, display brightness input by a user to determine the display brightness needed by the display apparatus when the manual mode is determined.

3. The method according to claim I, wherein
a light source brightness adjusting element is used to change duty ratio or current intensity of an input current of the light source, so as to adjust the brightness of the light source; and/or
a gray scale adjusting element is used to adjust the light transmissivity of the white sub-pixel.

4. The method according to claim 1, further comprising:
transmitting, by the brightness determining unit, a brightness control signal to the brightness adjusting unit; and
adjusting, by the brightness adjusting unit, at least one of the brightness of the light source and the light transmissivity of the white sub-pixel according to the brightness control signal received by the brightness adjusting unit.

5. The method according to claim 2, further comprising:
transmitting, by the brightness determining unit, a brightness control signal to the brightness adjusting unit; and
adjusting, by the brightness adjusting unit, at least one of the brightness of the light source and the light transmissivity of the white sub-pixel according to the brightness control signal received by the brightness adjusting unit.

6. The method according to claim 3, further comprising:
transmitting, by the brightness determining unit, a brightness control signal to the brightness adjusting unit; and
adjusting, by the brightness adjusting unit, at least one of the brightness of the light source and the light transmissivity of the white sub-pixel according to the brightness control signal received by the brightness adjusting unit.

7. An apparatus for adjusting display brightness of a display apparatus, the display apparatus comprising a light source and multiple pixel units arranged in arrays and at least one of the multiple pixel units comprising a white sub-pixel, the apparatus comprising:
a brightness determining unit for determining display brightness needed by the display apparatus; and
a brightness adjusting unit for adjusting at least one of brightness of the light source and light transmissivity of the white sub-pixel according to the display brightness determined by the brightness determining unit to obtain the display brightness needed by the display apparatus.

8. The apparatus according to claim 7, further comprising a mode determining unit for determining a brightness determining mode, the brightness determining mode including an automatic mode and a manual mode,
wherein the brightness determining unit comprises:
a light detecting element for detecting light intensity of the environment around the display apparatus to determine the display brightness needed by the display apparatus when the automatic mode is determined; and
a user input detecting element for detecting display brightness input by a user to determine the display brightness needed by the display apparatus when the manual mode is determined.

9. The apparatus according to claim 7, wherein the brightness adjusting unit comprises:
a light source brightness adjusting element for changing duty ratio or current intensity of an input current of the light source, so as to adjust the brightness of the light source; and
a gray scale adjusting element for adjusting the light transmissivity of the white sub-pixel.

10. The apparatus according to claim 7, wherein
the brightness determining unit is also used for transmitting a brightness control signal to the brightness adjusting unit according to the determined brightness; and
the brightness adjusting unit receives the brightness control signal to adjust the brightness of the light source and/or the light transmissivity of the white sub-pixel.

11. The apparatus according to claim 8, wherein
the brightness determining unit is also used for transmitting a brightness control signal to the brightness adjusting unit according to the determined brightness; and
the brightness adjusting unit receives the brightness control signal to adjust the brightness of the light source and/or the light transmissivity of the white sub-pixel.

12. The apparatus according to claim 9, wherein
the brightness determining unit is also used for transmitting a brightness control signal to the brightness adjusting unit according to the determined brightness; and
the brightness adjusting unit receives the brightness control signal to adjust the brightness of the light source and/or the light transmissivity of the white sub-pixel.

13. A display apparatus comprising a light source and multiple pixel units arranged in arrays, at least one of the multiple pixel units comprising a white sub-pixel, and the display apparatus further comprises an apparatus for adjusting display brightness of the display apparatus according to claim 7.

14. The display apparatus according to claim 13, further comprising a mode determining unit for determining a brightness determining mode, the brightness determining mode including an automatic mode and a manual mode,
wherein the brightness determining unit comprises:
a light detecting element for detecting light intensity of the environment around the display apparatus to determine the display brightness needed by the display apparatus when the automatic mode is determined; and
a user input detecting element for detecting display brightness input by a user to determine the display brightness needed by the display apparatus when the manual mode is determined.

15. The display apparatus according to claim 13, wherein the brightness adjusting unit of the apparatus for adjusting display brightness comprises:
a light source brightness adjusting element for changing duty ratio or current intensity of the input current of the light source to adjust the brightness of the light source; and
a gray scale adjusting element for adjusting the light transmissivity of the white sub-pixel.

16. The display apparatus according to claim 13, wherein the brightness determining unit of the apparatus for adjusting display brightness is also used for transmitting a brightness control signal to the brightness adjusting unit according to the determined brightness; and
the brightness adjusting unit receives the brightness control signal to adjust the brightness of the light source and/or the light transmissivity of the white sub-pixel.

17. The display apparatus according to claim 14, wherein the brightness determining unit of the apparatus for adjusting display brightness is also used for transmitting a brightness control signal to the brightness adjusting unit according to the determined brightness; and
the brightness adjusting unit receives the brightness control signal to adjust the brightness of the light source and/or the light transmissivity of the white sub-pixel.

18. The display apparatus according to claim 15, wherein the brightness determining unit of the apparatus for adjusting display brightness is also used for transmitting a brightness control signal to the brightness adjusting unit according to the determined brightness; and
the brightness adjusting unit receives the brightness control signal to adjust the brightness of the light source and/or the light transmissivity of the white sub-pixel.
